(19) United States
(12) Patent Application Publication
(10) Pub. No.: US 2026/0227740 A1
(43) Pub. Date: Aug. 6, 2026

(54) TONER ACCOMMODATING CONTAINER AND IMAGE FORMING APPARATUS

(71) Applicant: FUJIFILM Business Innovation Corp., Tokyo (JP)

(72) Inventors: Haruno NAGUMO, Kanagawa (JP); Yosuke NINOMIYA, Kanagawa (JP); Takafumi WAKAI, Kanagawa (JP); Tomohiro TAKEDA, Kanagawa (JP)

(73) Assignee: FUJIFILM Business Innovation Corp., Tokyo (JP)

(21) Appl. No.: 19/296,999

(22) Filed: Aug. 12, 2025

(30) Foreign Application Priority Data
Feb. 5, 2025 (JP) 2025-017902

(51) Int. Cl. G03G 21/16; G03G 15/08

(52) U.S. Cl. CPC G03G 21/1676; G03G 15/0867; G03G 15/0882; G03G 2215/0678; G03G 2221/163

(57) ABSTRACT

A toner accommodating container includes an accommodating member in which an opening portion for accommodating a toner is formed, a closing member that has a circular shape as viewed from an opening direction of the opening portion, that has an outer peripheral portion, on which an engaged portion which is engaged with an engaging portion formed along an inner peripheral edge of the opening portion is formed, and that closes the opening portion, and a grip portion that is provided at the closing member, that is grippable, and that is pulled in the opening direction to detach the closing member from the accommodating member.

### CROSS-REFERENCE TO RELATED APPLICATIONS

This application is based on and claims priority under 35 USC 119 from Japanese Patent Application No. 2025-017902 filed February 5, 2025.

### BACKGROUND

### i Technical Field

The present invention relates to a toner accommodating container and an image forming apparatus.

### ii Related Art

In a toner accommodating container described in JP2005-148343A, a toner cap of toner accommodating container has a cylindrical shape closing a bottom portion. The toner cap is provided with an engaging portion that engages a tip engaging portion of a rod-shaped detaching jig when detaching the toner cap from a toner port of a container case. The engaging portion is, for example, a recessed portion provided at the center of the toner cap. During detachment, for example, a handle of the detaching jig is held, and the tip engaging portion of the detaching jig is pressed and engaged with the engaging portion of the toner cap to integrate the toner cap and the detaching jig. Then, a force is applied to the detaching jig to detach the toner cap from the toner port of the toner accommodating container.

### SUMMARY

The toner accommodating container includes an accommodating member, in which an opening portion for accommodating a toner is formed, and a closing member that closes the opening portion. In the related art, the closing member is detached from the accommodating member using a jig.

Aspects of non-limiting embodiments of the present disclosure relate to a toner accommodating container and an image forming apparatus that detach a closing member from an accommodating member without using a jig.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner accommodating container including an accommodating member in which an opening portion for accommodating a toner is formed, a closing member that has a circular shape as viewed from an opening direction of the opening portion, that has an outer peripheral portion, on which an engaged portion which is engaged with an engaging portion formed along an inner peripheral edge of the opening portion is formed, and that closes the opening portion, and a grip portion that is provided at the closing member, that is grippable, and that is pulled in the opening direction to detach the closing member from the accommodating member.

### BRIEF DESCRIPTION OF THE DRAWINGS

Exemplary embodiment(s) of the present invention will be described in detail based on the following figures, wherein:

FIG. 1 is a schematic configuration view showing an image forming apparatus according to a first exemplary embodiment of the present disclosure;

FIG. 2 is a configuration view showing a toner image forming unit included in the image forming apparatus according to the first exemplary embodiment of the present disclosure;

FIG. 3 is a perspective view showing a toner accommodating container according to the first exemplary embodiment of the present disclosure;

FIGS. 4A and 4B are a cross-sectional view and a front view showing a closing member and the like included in the toner accommodating container according to the first exemplary embodiment of the present disclosure;

FIG. 5 is a front view showing a closing member and the like included in a toner accommodating container according to a second exemplary embodiment of the present disclosure;

FIG. 6 is a perspective view showing a closing member and the like included in a toner accommodating container according to a third exemplary embodiment of the present disclosure;

FIG. 7 is a perspective view showing a closing member and the like included in a toner accommodating container according to a fourth exemplary embodiment of the present disclosure;

FIG. 8 is a perspective view showing a closing member and the like included in a toner accommodating container according to a fifth exemplary embodiment of the present disclosure; and

FIGS. 9A and 9B are front views showing a closing member and the like included in a toner accommodating container according to a sixth exemplary embodiment of the present disclosure.

### DETAILED DESCRIPTION

### First Exemplary Embodiment

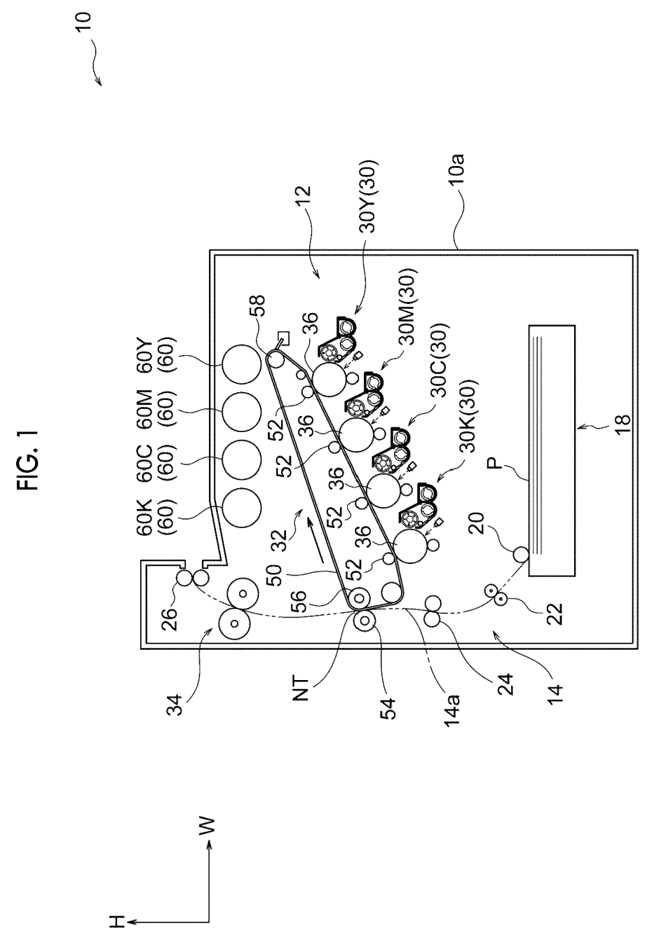

An example of a toner accommodating container and an image forming apparatus according to a first exemplary embodiment of the present disclosure will be described with reference to FIGS. 1 to 4. An arrow H shown in each drawing indicates an up-down direction of the apparatus, which is a vertical direction. An arrow W is orthogonal to the arrow H and indicates a width direction of the apparatus, which is a horizontal direction. An arrow D is orthogonal to the arrows H and W and indicates a depth direction of the apparatus, which is a horizontal direction.

### Overall Configuration of Image Forming Apparatus 10

As shown in FIG. 1, an image forming apparatus 10 includes an image forming unit 12 that forms a toner image and a transport unit 14 that transports a sheet member P along a transport path 14a. In addition, the image forming apparatus 10 includes an accommodating member 18 that accommodates the sheet member P and a toner accommodating container 60 that accommodates a toner.

In this configuration, in the image forming apparatus 10, the sheet member P accommodated in the accommodating member 18 is transported by the transport unit 14 along the transport path 14a. Further, a toner image is formed by the image forming unit 12 using a toner supplied from the toner accommodating container 60. In addition, the toner image is formed on the transported sheet member P, and the sheet member P on which the toner image is formed is discharged to the outside of an apparatus body 10a.

### Image Forming Unit 12

As shown in FIG. 1, the image forming unit 12 includes a plurality of toner image forming units 30 that form toner images of respective colors and a transfer unit 32 that transfers the toner images formed by the toner image forming units 30 to the sheet member P. Further, the image forming unit 12 includes a fixing device 34 that fixes the toner images, which are transferred to the sheet member P by the transfer unit 32, to the sheet member P.

### Toner Image Forming Unit 30

The plurality of toner image forming units 30 are provided to form a toner image for each color. In the present exemplary embodiment, in total, four colors of yellow (Y), magenta (M), cyan (C), and black (K) toner image forming units 30Y, 30M, 30C, and 30K are provided. In the following description, in a case where it is not necessary to distinguish between yellow (Y), magenta (M), cyan (C), and black (K), Y, M, C, and K attached to the reference symbols are omitted.

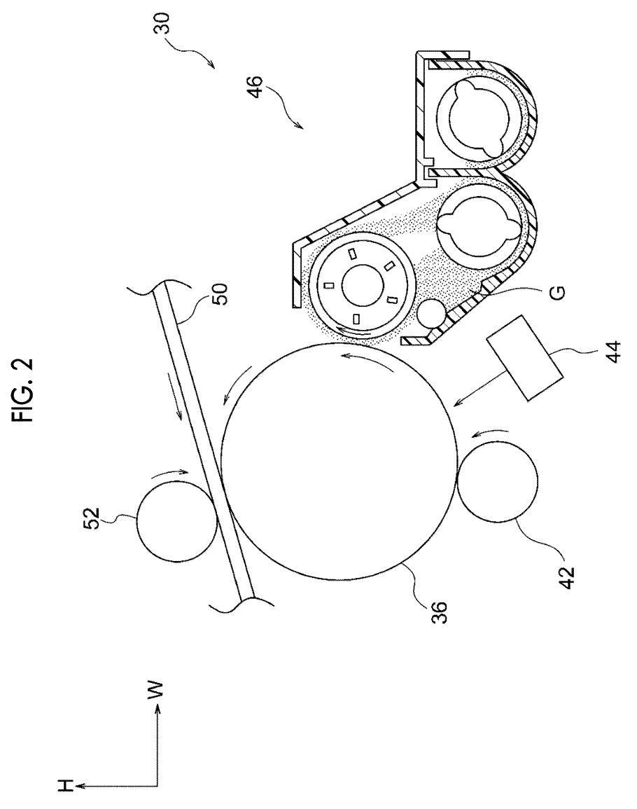

The toner image forming units 30 of respective colors have basically the same configuration except for a toner to be used and, as shown in FIG. 2, each includes a rotating image holder 36 having a columnar shape and a charger 42 that charges the image holder 36. Further, the toner image forming unit 30 includes an exposure device 44 that irradiates the charged image holder 36 with exposure light to form an electrostatic latent image and a developing device 46 that develops the electrostatic latent image with a developer G containing a toner as a toner image. Accordingly, the toner image forming unit 30 of each color forms an image of each color using a toner of each color.

In addition, as shown in FIG. 1, the image holder 36 of each color is in contact with a transfer belt 50 (details to be described later) that moves circumferentially. In a circumferential direction (see an arrow in the drawing) of the transfer belt 50, the yellow (Y), magenta (M), cyan (C), and black (K) toner image forming units 30 are arranged in this order from an upstream side.

### Transfer Unit 32

As shown in FIG. 1, the transfer unit 32 includes the transfer belt 50 and primary transfer rolls 52 that are each arranged on an opposite side of the image holder 36 of each color with the transfer belt 50 sandwiched therebetween. The primary transfer roll 52 transfers the toner image formed on the image holder 36 of each color to the transfer belt 50.

In addition, the transfer unit 32 includes a winding roll 56 around which the transfer belt 50 is wound and a drive roll 58 around which the transfer belt 50 is wound and which transmits a rotational force to the transfer belt 50. Accordingly, the transfer belt 50 moves circumferentially in an arrow direction in the drawing.

Further, the transfer unit 32 includes a secondary transfer roll 54 arranged on an opposite side of the winding roll 56 with the transfer belt 50 sandwiched therebetween. The secondary transfer roll 54 transfers a toner image transferred to the transfer belt 50 to the sheet member P. A transfer nip NT where the toner image is transferred to the sheet member P is formed between the secondary transfer roll 54 and the transfer belt 50.

In this configuration, a toner image is primarily transferred to the transfer belt 50 by the primary transfer rolls 52 in order of yellow (Y), magenta (M), cyan (C), and black (K). In addition, the toner image is transferred from the transfer belt 50 to the sheet member P, which is sandwiched between the transfer belt 50 and the secondary transfer roll 54 and is transported, by the secondary transfer roll 54. Further, the sheet member P to which the toner image is transferred is transported toward the fixing device 34.

### Fixing Device 34

As shown in FIG. 1, the fixing device 34 is arranged on a downstream side of the transfer nip NT in a transport direction of the sheet member P. The fixing device 34 heats and pressurizes a toner image transferred to the sheet member P to fix the toner image to the sheet member P.

### Transport Unit 14

As shown in FIG. 1, the transport unit 14 includes a feeding roll 20 that feeds the sheet member P accommodated in the accommodating member 18 to the transport path 14a and a prevention roll 22 that prevents double-feeding of the sheet member P fed by the feeding roll 20. Further, the transport unit 14 includes an adjustment roll 24 that adjusts a timing of the sheet member P being fed to the transfer nip NT. In addition, the transport unit 14 includes a discharge roll 26 that discharges the sheet member P to which a toner image is fixed by the fixing device 34 to the outside of the apparatus body 10a.

### Toner Accommodating Container 60

A plurality of toner accommodating containers 60 are provided for each color developing device 46 (see FIG. 2). In the present exemplary embodiment, as shown in FIG. 1, in total, four colors of yellow (Y), magenta (M), cyan (C), and black (K) toner accommodating containers 60Y, 60M, 60C, and 60K are provided. In the following description, in a case where it is not necessary to distinguish between yellow (Y), magenta (M), cyan (C), and black (K), Y, M, C, and K attached to the reference symbols are omitted. In addition, details of the toner accommodating container 60 will be described later.

### Major Portion Configuration

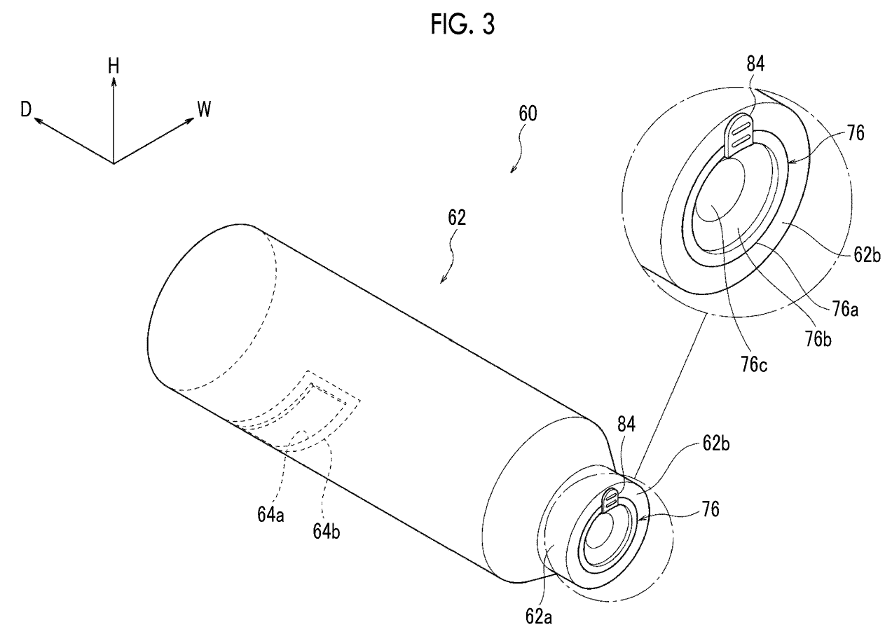

Next, the toner accommodating container 60 will be specifically described. As shown in FIG. 3, the toner accommodating container 60 includes an accommodating member 62 and a closing member 76.

### Accommodating Member 62

The accommodating member 62 is formed of a resin material (for example, an ABS resin), has a cylindrical shape extending in the depth direction, and accommodates a toner therein as shown in FIG. 3. A supply port 64a for supplying the toner therein to the developing device 46 (see FIG. 2) and a shutter 64b for opening and closing the supply port 64a are provided in a lower portion of a peripheral surface of the accommodating member 62 on a back side in the depth direction. Further, an agitating member (not shown) that agitates the toner is provided inside the accommodating member 62.

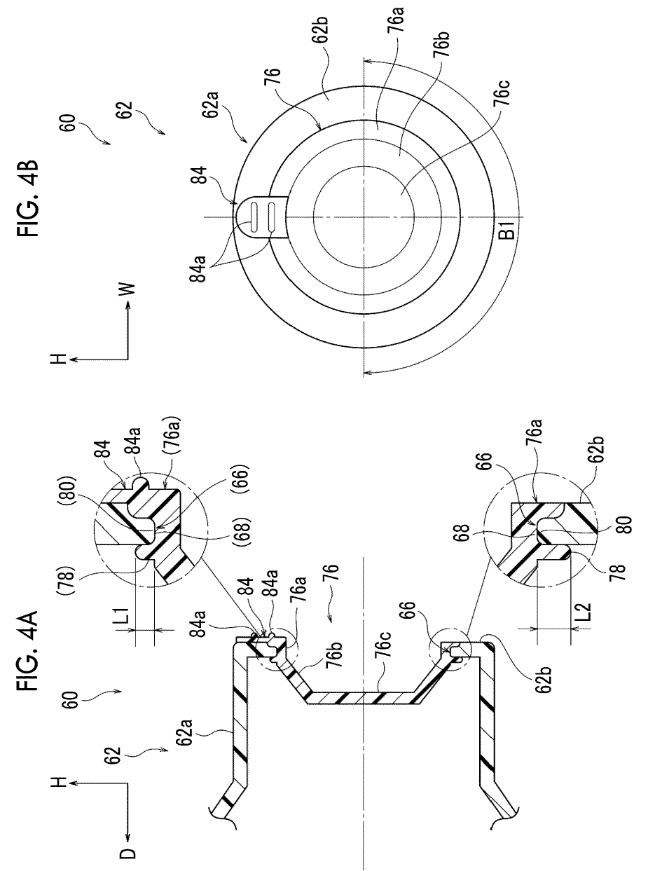

In addition, a tapered cylindrical portion 62a that is smaller in diameter than a general portion is formed on a front side of the accommodating member 62 in the depth direction. Further, an end surface 62b facing the front side in the depth direction is formed at an end portion of the cylindrical portion 62a on the front side in the depth direction. In addition, as shown in FIG. 4A, an opening portion 66 for accommodating a toner is formed in the end surface 62b to face the depth direction. In other words, the opening portion 66 is formed to open the inside of the accommodating member 62 to the front side in the depth direction. Then, the opening portion 66 is circular as viewed from the depth direction. The depth direction is an example of an opening direction, and the opening direction is a direction orthogonal to the opening portion 66.

In addition, an engaging portion 68 that is recessed to the back side in the depth direction with respect to the end surface 62b and that protrudes to an inside in a radial direction of the opening portion 66 is formed in the opening portion 66. The engaging portion 68 is formed over the entire region along an inner peripheral edge of the opening portion 66.

### Closing Member 76

The closing member 76 is formed of a resin material (for example, a polyethylene resin) and closes the opening portion 66 as shown in FIGS. 3 and 4A.

As viewed from the front side in the depth direction, an outer peripheral edge of the closing member 76 is circular as shown in FIG. 4B and is arranged inside an outer peripheral edge of the end surface 62b. As shown in FIGS. 4A and 4B, the closing member 76 is formed to include an annular outer peripheral portion 76a, a conical portion 76b, a disk portion 76c, and a grip portion 84.

### Outer Peripheral Portion 76a, Conical Portion 76b, And Disk Portion 76c

The conical portion 76b is a conical portion extending from the outer peripheral portion 76a to the back side in the depth direction, and the disk portion 76c is a circular plate portion that is provided at a tip of the conical portion 76b and has a plate surface facing the depth direction.

In addition, an engaged portion 78 that comes into contact with the engaging portion 68 of the opening portion 66 in the depth direction and that overlaps in the radial direction of the opening portion 66 (hereinafter, simply referred to as the “radial direction”) is formed in the outer peripheral portion 76a. Further, in the outer peripheral portion 76a, a contact surface 80 that is in contact with a tip of the engaging portion 68 in the radial direction is formed in a portion on the front side in the depth direction with respect to the engaged portion 78. The radial direction of the opening portion 66 is an example of an intersection direction intersecting the opening direction.

### Grip Portion 84

As shown in FIGS. 3, 4A, and 4B, the grip portion 84 extends from the outer peripheral portion 76a along the end surface 62b. Specifically, a base end of the grip portion 84 is attached to an upper portion of the outer peripheral portion 76a. The grip portion 84 extends upward and is grippable. As described above, the grip portion 84 is arranged on the opposite side of the supply port 64a (see FIG. 3) as viewed from the depth direction. Here, the term “grippable” means that an operator whose index finger has a ring size of 17 and whose thumb has a ring size of 20 can grip the grip portion 84. In the present exemplary embodiment, a gap between the grip portion 84 and the end surface 62b is, for example, 0 [mm] or more and 2 [mm] or less.

In addition, the grip portion 84 has a plate shape of which a plate thickness direction is the depth direction, and a tip portion has an arc shape. As viewed from the depth direction, the entire grip portion 84 is arranged inside the outer peripheral edge of the end surface 62b (see FIG. 4B).

In addition, two protruding portions 84a for slip prevention are formed on a plate surface of the grip portion 84 facing the front side in the depth direction.

### Others

As viewed from the depth direction, an overlap amount in the radial direction between the engaged portion 78 and the engaging portion 68 in a portion where the grip portion 84 is formed is defined as L1 in FIG. 4A. In addition, an overlap amount between the engaged portion 78 and the engaging portion 68 in a portion on the opposite side to the portion where the grip portion 84 is formed is defined as L2 in FIG. 4A. In this case, the overlap amount L1 is smaller than the overlap amount L2. Accordingly, an engaging force in the portion where the grip portion 84 is formed is weakened compared to an engaging force in the portion on the opposite side to the portion where the grip portion 84 is formed. Herein, the portion on the opposite side to the portion where the grip portion 84 is formed is a portion (B1 shown in FIG. 4B) of the grip portion 84 on the opposite side with the center of the closing member 76 interposed therebetween as viewed from the depth direction.

In the present exemplary embodiment, the engaged portion 78 and the engaging portion 68 in the portion between the portion B1 on the opposite side and the portion where the grip portion 84 is formed are equal to or larger than the overlap amount L1 and equal to or smaller than the overlap amount L2.

In this configuration, the operator grips the grip portion 84 and pulls the grip portion 84 to the front side in the depth direction, so that the closing member 76 is detached from the accommodating member 62. Specifically, by pulling the grip portion 84 to the front side in the depth direction, first, engagement between the engaged portion 78 and the engaging portion 68 in the vicinity of the grip portion 84 is released. Further, by pulling the grip portion 84 to the front side in the depth direction, the entire engagement is released with a portion where the engagement is released as a starting point. Then, the closing member 76 is detached from the accommodating member 62.

### Outline

As described above, in the toner accommodating container 60, the closing member 76 is detached from the accommodating member 62 without using a jig.

In addition, in the toner accommodating container 60, the opening portion 66 is opened without breaking the closing member 76. In other words, the closing member 76 and the accommodating member 62 constituting the toner accommodating container 60 are reused.

In addition, in the toner accommodating container 60, the grip portion 84 extends from the outer peripheral portion 76a of the closing member 76 along the end surface 62b. Accordingly, mistakenly gripping the grip portion 84 is suppressed compared to a case where the grip portion extends to the front side in the depth direction.

In addition, in the toner accommodating container 60, the entire grip portion 84 is arranged inside the outer peripheral edge of the end surface 62b as viewed from the depth direction. Accordingly, mistakenly gripping the grip portion 84 is suppressed compared to a case where the grip portion protrudes from the end surface as viewed from the depth direction.

In addition, in the toner accommodating container 60, the engaging force in the portion where the grip portion 84 is formed is weakened compared to the engaging force in the portion on the opposite side to the portion where the grip portion 84 is formed. Accordingly, the closing member 76 is easily detached from the accommodating member 62 compared to a case where the engaging force in the portion where the grip portion is formed is the same as the engaging force in the portion on the opposite side.

In addition, in the toner accommodating container 60, the overlap amount L1 of the portion where the grip portion 84 is formed is smaller than the overlap amount L2 of the portion on the opposite side. Accordingly, the engaging force is changed with a simple configuration compared to a case where the engaging force is changed using an adhesive.

In addition, in the image forming apparatus 10, the toner accommodating container 60 in which the closing member 76 and the accommodating member 62 are reused is mounted.

### Second Exemplary Embodiment

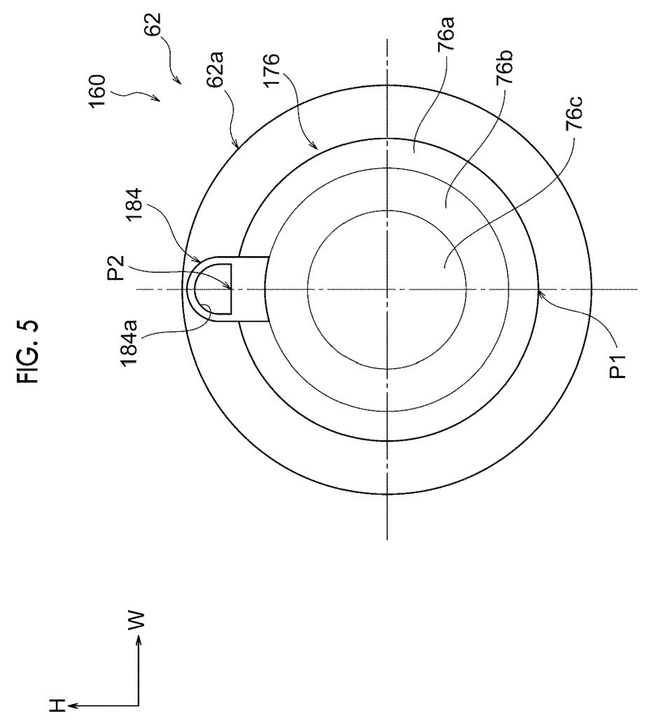

An example of a toner accommodating container and an image forming apparatus according to a second exemplary embodiment of the present disclosure will be described with reference to FIG. 5. The second exemplary embodiment will be described largely focusing on differences from the first exemplary embodiment.

As shown in FIG. 5, a toner accommodating container 160 according to the second exemplary embodiment includes the accommodating member 62 and a closing member 176.

A through-hole 184a penetrating the front and back surfaces is formed in a grip portion 184 of the closing member 176 for slip prevention.

In addition, an overlap amount (see FIG. 4A) in the radial direction between the engaged portion 78 and the engaging portion 68 as viewed from the depth direction is the largest at a portion P1 on the opposite side to a portion where the grip portion 184 is formed and is the smallest at a portion P2 where the grip portion 184 is formed. Specifically, the overlap amount in the radial direction between the engaged portion 78 and the engaging portion 68 gradually changes from the portion P2 to the portion P1. Accordingly, an engaging force in the portion where the grip portion 184 is formed is weakened compared to an engaging force in a portion on the opposite side to the portion where the grip portion 184 is formed.

### Third Exemplary Embodiment

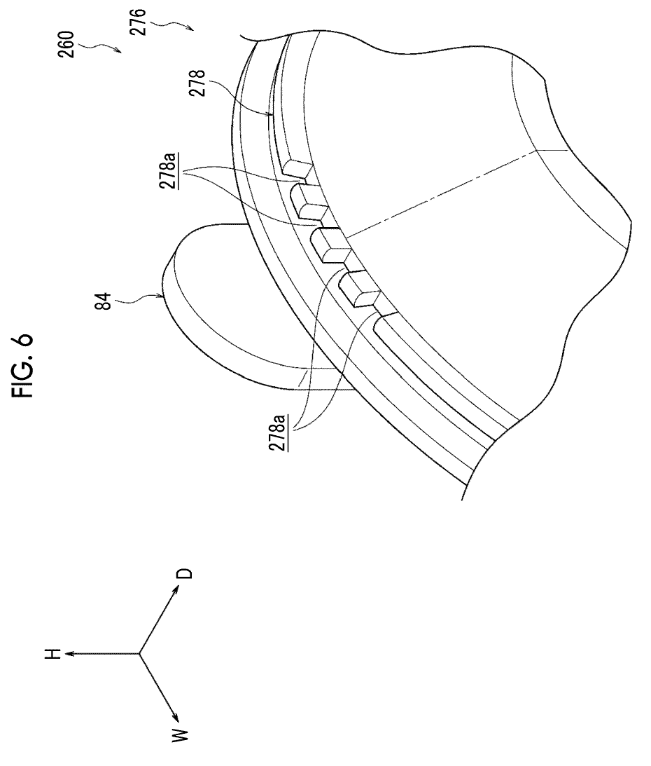

An example of a toner accommodating container and an image forming apparatus according to a third exemplary embodiment of the present disclosure will be described with reference to FIG. 6. The third exemplary embodiment will be described largely focusing on differences from the first exemplary embodiment.

As shown in FIG. 6, a toner accommodating container 260 according to the third exemplary embodiment includes the accommodating member 62 (see FIG. 3) and a closing member 276.

A height of an engaged portion 278 formed in the closing member 276 is the same over the entire periphery. Further, a plurality of notches 278a obtained by cutting out a part of the engaged portion 278 are formed in the engaged portion 278 of the portion where the grip portion 84 is formed as viewed from the depth direction. Accordingly, an engaging force in the portion where the grip portion 84 is formed is weakened compared to an engaging force in a portion on the opposite side to the portion where the grip portion 84 is formed.

### Fourth Exemplary Embodiment

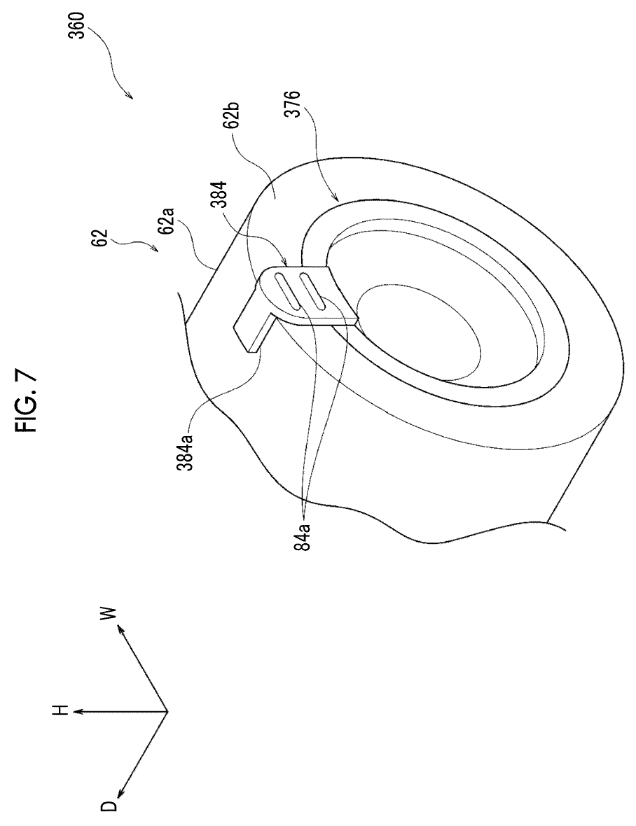

An example of a toner accommodating container and an image forming apparatus according to a fourth exemplary embodiment of the present disclosure will be described with reference to FIG. 7. The fourth exemplary embodiment will be described largely focusing on differences from the first exemplary embodiment.

As shown in FIG. 7, a toner accommodating container 360 according to the fourth exemplary embodiment includes the accommodating member 62 and a closing member 376.

A tip of a grip portion 384 of the closing member 376 protrudes from the outer peripheral edge of the end surface 62b. Further, a hook portion 384a that comes into contact with an outer peripheral surface of the cylindrical portion 62a and that extends to the back side in the depth direction is connected to a portion of the grip portion 384 that protrudes. Accordingly, mistakenly gripping the grip portion 84 is suppressed.

### Fifth Exemplary Embodiment

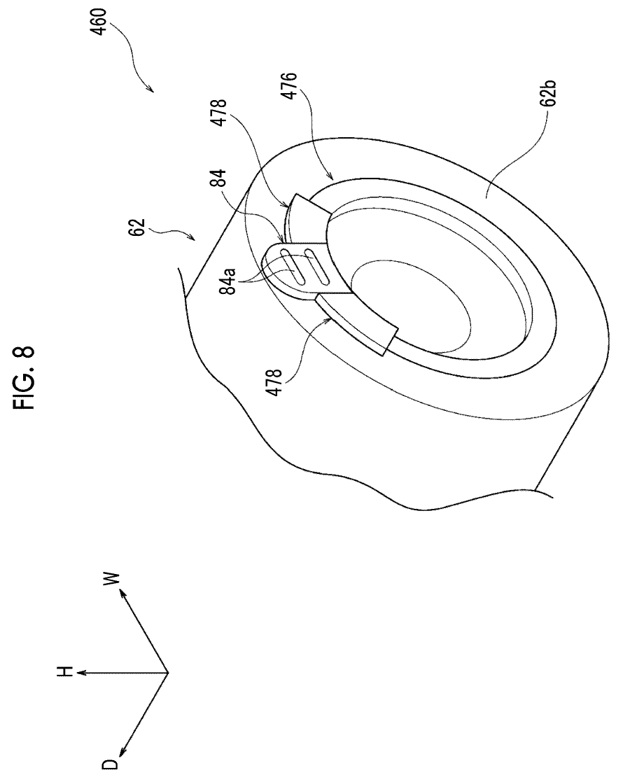

An example of a toner accommodating container and an image forming apparatus according to a fifth exemplary embodiment of the present disclosure will be described with reference to FIG. 8. The fifth exemplary embodiment will be described largely focusing on differences from the first exemplary embodiment.

As shown in FIG. 8, a toner accommodating container 460 according to the fifth exemplary embodiment includes the accommodating member 62 and a closing member 476.

In the closing member 476, a stepped portion 478 that covers the end surface 62b from the front side in the depth direction is formed on both sides of the grip portion 84. The stepped portion 478 has a plate shape and is in contact with the end surface 62b in the depth direction. Accordingly, even in a case where the grip portion 84 is mistakenly pulled to the front side in the depth direction, leaking of a toner accommodated in the accommodating member 62 from the opening portion 66 (see FIG. 4A) to the outside is suppressed compared to a case where the stepped portion is not formed.

### Sixth Exemplary Embodiment

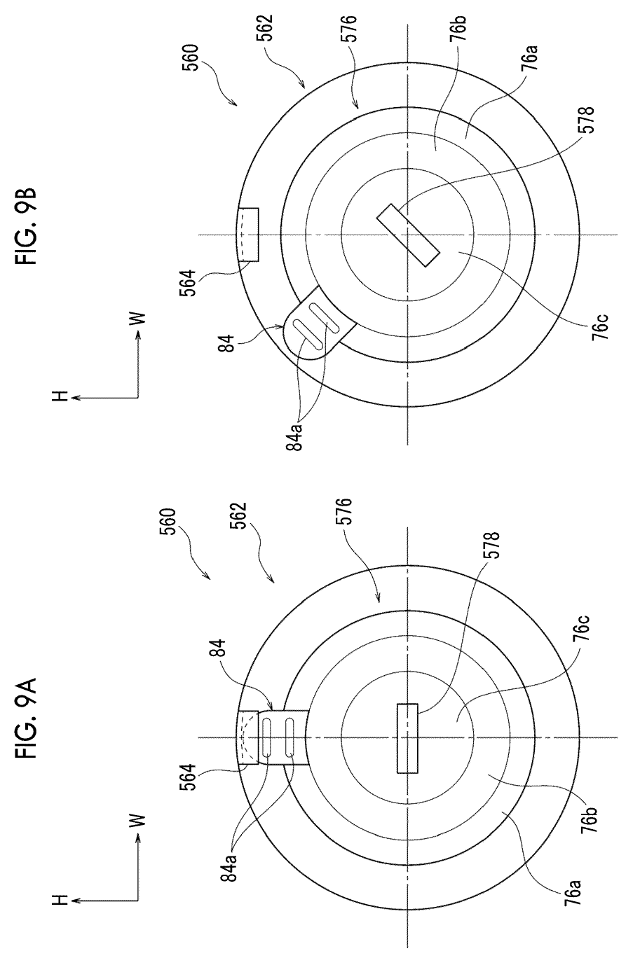

An example of a toner accommodating container and an image forming apparatus according to a sixth exemplary embodiment of the present disclosure will be described with reference to FIGS. 9A and 9B. The sixth exemplary embodiment will be described largely focusing on differences from the first exemplary embodiment.

As shown in FIGS. 9A and 9B, a toner accommodating container 560 according to the sixth exemplary embodiment includes an accommodating member 562 and a closing member 576.

A knob portion 578 that can be pinched by the operator is formed on the disk portion 76c of the closing member 576. In addition, as shown in FIG. 9A, in the accommodating member 562, a covering portion 564 that covers a tip of the grip portion 84 from the front side in the depth direction is formed at an initial position of the closing member 576 arranged such that the grip portion 84 extends upward.

In this configuration, in a state where the closing member 576 is arranged at the initial position, the tip of the grip portion 84 is covered with the covering portion 564. Therefore, mistakenly gripping the grip portion 84 is suppressed (see FIG. 9A). Further, in a case where the knob portion 578 of the closing member 576 arranged at the initial position is pinched and the closing member 576 is rotated counterclockwise as viewed from the depth direction, the grip portion 84 is exposed (see FIG. 9B). In this state, the grip portion 84 is gripped and pulled to the front side in the depth direction, so that the closing member 576 is detached from the accommodating member 562.

Although details of certain exemplary embodiments of the present disclosure have been described, the present disclosure is not limited to such exemplary embodiments, and it is clear for those skilled in the art that the present disclosure can take other various exemplary embodiments within the scope of the present disclosure. The exemplary embodiments described above are merely examples for description, and the present disclosure is not limited thereto. Changes, deletions, additions, and combinations are possible unless departing from the technical idea of the present invention that can be recognized by those skilled in the art from the description of the claims, the specification, and the drawings.

In addition, in the exemplary embodiments described above, the grip portions 84, 184, and 384 extend along the end surface 62b, but the grip portions may extend to protrude to the front side in the depth direction. In this case, action that is exerted by extending along the end surface 62b is not exerted.

In addition, in the exemplary embodiments, the number of the grip portions 84, 184, and 384 is one, but may be plural.

In addition, in the first exemplary embodiment, the entire grip portion 84 is arranged inside the outer peripheral edge of the end surface 62b, but a part of the grip portion may protrude from the outer peripheral edge of the end surface. However, in this case, the action that is exerted by arranging the entire grip portion 84 inside the outer peripheral edge of the end surface 62b is not exerted.

### (((1)))

A toner accommodating container comprising:

an accommodating member in which an opening portion for accommodating a toner is formed;

a closing member that has a circular shape as viewed from an opening direction of the opening portion, that has an outer peripheral portion, on which an engaged portion which is engaged with an engaging portion formed along an inner peripheral edge of the opening portion is formed, and that closes the opening portion; and

a grip portion that is provided at the closing member, that is grippable, and that is pulled in the opening direction to detach the closing member from the accommodating member.

### (((2)))

The toner accommodating container according to (((1))),

wherein the accommodating member extends in the opening direction,

the opening portion is formed in an end surface of the accommodating member, which faces the opening direction,

as viewed from the opening direction, an outer peripheral edge of the closing member is arranged inside an outer peripheral edge of the end surface, and

the grip portion extends along the end surface from the outer peripheral portion of the closing member.

### (((3)))

The toner accommodating container according to (((2))),

wherein as viewed from the opening direction, the entire grip portion is arranged inside the outer peripheral edge of the end surface.

### (((4)))

The toner accommodating container according to any one of claims (((1))) to (((3))),

wherein one grip portion is formed at the closing member, and

an engaging force between the engaged portion and the engaging portion in a portion where the grip portion is formed as viewed from the opening direction is weaker than an engaging force between the engaged portion and the engaging portion in a portion on an opposite side to the portion where the grip portion is formed as viewed from the opening direction.

### (((5)))

The toner accommodating container according to (((4))),

wherein the engaged portion and the engaging portion come into contact with each other in the opening direction and overlap each other in an intersection direction intersecting the opening direction, and

as viewed from the opening direction, an overlap amount in the intersection direction between the engaged portion and the engaging portion in the portion where the grip portion is formed is smaller than an overlap amount in the intersection direction between the engaged portion and the engaging portion in the portion on the opposite side.

### (((6)))

An image forming apparatus comprising:

the toner accommodating container according to any one of (((1))) to (((5))); and

a developing device that develops an electrostatic latent image, which is formed on an image holder, using a toner supplied from the toner accommodating container into a toner image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A toner accommodating container comprising:
an accommodating member in which an opening portion for accommodating a toner is formed;
a closing member that has a circular shape as viewed from an opening direction of the opening portion, that has an outer peripheral portion, on which an engaged portion which is engaged with an engaging portion formed along an inner peripheral edge of the opening portion is formed, and that closes the opening portion; and
a grip portion that is provided at the closing member, that is grippable, and that is pulled in the opening direction to detach the closing member from the accommodating member.

2. The toner accommodating container according to claim 1,
wherein the accommodating member extends in the opening direction,
the opening portion is formed in an end surface of the accommodating member, which faces the opening direction,
as viewed from the opening direction, an outer peripheral edge of the closing member is arranged inside an outer peripheral edge of the end surface, and
the grip portion extends along the end surface from the outer peripheral portion of the closing member.

3. The toner accommodating container according to claim 2,
wherein as viewed from the opening direction, the entire grip portion is arranged inside the outer peripheral edge of the end surface.

4. The toner accommodating container according to claim 1,
wherein one grip portion is formed at the closing member, and
an engaging force between the engaged portion and the engaging portion in a portion where the grip portion is formed as viewed from the opening direction is weaker than an engaging force between the engaged portion and the engaging portion in a portion on an opposite side to the portion where the grip portion is formed as viewed from the opening direction.

5. The toner accommodating container according to claim 4,
wherein the engaged portion and the engaging portion come into contact with each other in the opening direction and overlap each other in an intersection direction intersecting the opening direction, and
as viewed from the opening direction, an overlap amount in the intersection direction between the engaged portion and the engaging portion in the portion where the grip portion is formed is smaller than an overlap amount in the intersection direction between the engaged portion and the engaging portion in the portion on the opposite side.

6. An image forming apparatus comprising:
the toner accommodating container according to claim 1; and
a developing device that develops an electrostatic latent image, which is formed on an image holder, using a toner supplied from the toner accommodating container into a toner image.

7. An image forming apparatus comprising:
the toner accommodating container according to claim 2; and
a developing device that develops an electrostatic latent image, which is formed on an image holder, using a toner supplied from the toner accommodating container into a toner image.

8. An image forming apparatus comprising:
the toner accommodating container according to claim 3; and
a developing device that develops an electrostatic latent image, which is formed on an image holder, using a toner supplied from the toner accommodating container into a toner image.

9. An image forming apparatus comprising:
the toner accommodating container according to claim 4; and
a developing device that develops an electrostatic latent image, which is formed on an image holder, using a toner supplied from the toner accommodating container into a toner image.

10. An image forming apparatus comprising:
the toner accommodating container according to claim 5; and
a developing device that develops an electrostatic latent image, which is formed on an image holder, using a toner supplied from the toner accommodating container into a toner image.
